(19) United States
(12) Patent Application Publication
(10) Pub. No.: US 2023/0088496 A1
(43) Pub. Date: Mar. 23, 2023

(54) METHOD FOR VIDEO STREAMING

(71) Applicant: Robotics Networking and Automation, Inc., Dallas, TX (US)

(72) Inventors: Mark Nataros, Campton, NH (US); Joseph Tydlacka, Cibolo, TX (US)

(21) Appl. No.: 17/738,688

(22) Filed: May 6, 2022

Related U.S. Application Data
(60) Provisional application No. 63/247,446, filed on Sep. 23, 2021.

(51) Int. Cl. H04N 21/234; H04N 21/2187; H04N 21/239

(52) U.S. Cl. CPC H04N 21/23406; H04N 21/2187; H04N 21/2393

(57) ABSTRACT

A method for streaming live video includes encoding a video stream on a server, where the server is connected to a client through a network. The server receives a request from the client for a memory address of a first video frame and checks if the memory address of the first video frame has been bit shifted in a direct mapped memory buffer to determine if the first video frame is available. The server provides a memory address of an output video frame to the client in response to the request.

### PRIORITY CLAIM AND CROSS-REFERENCE

This application claims the benefit of U.S. Provisional Application No. 63/247,446, filed on Sep. 23, 2021, which application is hereby incorporated herein by reference.

### TECHNICAL FIELD

The present invention relates generally to a system and method for streaming live video, and, in particular embodiments, to a system and method for dynamically mapping memory to facilitate live video streaming.

### BACKGROUND

Live video streaming is a method of delivering video data over a network connection that does not require a client (e.g., a device receiving the streaming video) to download the full data of the video. Live stream data made up of image frames is sent from an image source (e.g., a camera) to a server where the video is encoded in order to compress the video by removing redundant visual information. The encoded video is then sent to the client, which decodes the video and may display it to a user in close to real time. The lag between the image source recording the video and the client displaying the video is called latency.

Generally, current live video streaming technologies do not provide for streaming of encoded frames with desirably low latency. The latency of the streaming may be increased when network conditions are not good (e.g., due to poor or intermittent connection) and the client receives missing or corrupt packets or data segments in the stream. Traditionally, TCP (Transmission Control Protocol) with buffering has been the approach used to resolve this latency issue. However, continuous buffering can force a delay in the frames presented, and using TCP may increase the probability for network traffic spikes and delays in subsequent frames being processed. Therefore, a new solution to provide for streaming of encoded frames with decreased latency is needed.

### SUMMARY

In accordance with an embodiment, a method for streaming live video includes: encoding a video stream on a server, where the server is connected to a client through a network; receiving a request from the client for a memory address of a first video frame; checking if the memory address of the first video frame has been bit shifted in a direct mapped memory buffer to determine if the first video frame is available; and providing a memory address of an output video frame to the client in response to the request.

In accordance with another embodiment, a method for streaming live video includes: encoding a video feed from an image source into a first video stream, where the first video stream includes a plurality of frames, the plurality of frames being located in memory on a first server; storing a respective memory address of each frame of the plurality of frames in a first memory buffer, the first memory buffer being on the first server; while writing data to a first frame of the plurality of frames, bit shifting respective memory addresses of each frame of the remainder of the plurality of frames by an offset; and providing the respective bit shifted memory addresses to a client.

In accordance with yet another embodiment, a computer with a computer readable storage medium stores programming for execution by the computer, the programming including instructions to: receive a first request on the computer for a first I-frame of a video stream from a client; receive a second request on the computer for a first delta frame of the video stream from the client, the first delta frame following the first I-frame in the video stream, where the first delta frame has not been generated on the computer when the second request is received; provide a first video frame to the client in response to the first request, the first video frame being the first I-frame; determine whether the first delta frame is available by checking if a memory address of the first delta frame in a direct mapped memory buffer of the computer has been bit shifted; and provide a second video frame to the client in response to the second request.

It is to be understood that both the foregoing general description and the following detailed description are exemplary and explanatory only and are not restrictive of the disclosure, as claimed.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a network including a server and a group of clients, in accordance with some embodiments;

FIG. 2A is a block diagram of a server, in accordance with some embodiments;

FIG. 2B is a flow chart for multiple simultaneous encoding streams, in accordance with some embodiments;

FIGS. 3 and 4 are flow charts for mapped memory addresses, in accordance with some embodiments;

FIG. 5 is a block diagram of a client, in accordance with some embodiments;

FIG. 6 is a block diagram of a network including a server, a rebroadcast server, and a group of clients, in accordance with some embodiments;

FIG. 7 is a block diagram of a network including a server and a group of clients, in accordance with some embodiments;

FIG. 8 is a flow chart of a method for streaming live video, in accordance with some embodiments;

FIG. 9 is a flow chart of a method for streaming live video, in accordance with some embodiments; and

FIG. 10 is a flow chart of a method for streaming live video, in accordance with some embodiments.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment. Moreover, particular conformations, structures, or characteristics may be combined in any adequate way in one or more embodiments. Likewise, it is contemplated that the respective teachings of the various embodiments disclosed herein could be combined, in whole or in part, to achieve additional embodiments and benefits, all of which are within the contemplated scope of the present disclosure.

The references used herein are provided merely for convenience and hence do not define the extent of protection or the scope of the embodiments. According to one or more embodiments of the present disclosure, a transport method for encoded video streams, referred to herein as H26Live, is provided. The video frames of the encoded video streams may be in a format consistent with other encodings such as H264, H265, H266, VP9, AV1, Huffyuv, Lagarith, JPEG XS, or the like.

Encodings may compress video streams by, e.g., converting the video stream into I-frames and delta frames. The uncompressed video stream is a series of video frames (also referred to as frames), each of which is a still image, that create moving pictures when the series of video frames are displayed in sequence at a desired number of frames per second (FPS). An exemplary encoder compresses the video stream into I-frames and delta frames. I-frames (also referred to as Intra frames or keyframes) are complete frames from the uncompressed stream. Delta frames store changes in portions of I-frames while the remainder of the I-frames remain the same. As an example, a video stream may show a car driving along a road, and a first I-frame is a snapshot of the car at a first position on the road. A first delta frame after the first I-frame could include the change in position of the car as it moves along the road. The rest of the road and surrounding terrain in the first I-frame are omitted from the delta frame as they are stationary and do not change in the time covered by the delta frame. Following delta frames may contain updates on the car as it moves along the road. While small changes in the video data may be represented by delta frames, larger changes in the video stream may be better represented by new I-frames. For example, a subsequent change in position of the camera recording the video stream may be represented by a second I-frame showing the different view of the road.

The method H26Live for streaming live video includes dynamically mapping the changes in frames (e.g., I-frames and delta frames) in memory to the most recent I-frame from an always up to date I-frame that is constantly available for streaming along with any standard I-frames or subsequent delta frames that may be useful. H₂6Live uses a dynamic memory mapped system that facilitates a streaming protocol including timing information in the data stream. However, unlike other methods for streaming live video that work by breaking the video stream down into small downloadable file chunks that are stored on the server, H26Live dynamically maps a set number of I-frames and delta-frames to specific memory locations. This protocol can increase frame access time by eliminating physical drive access times with direct memory mapping.

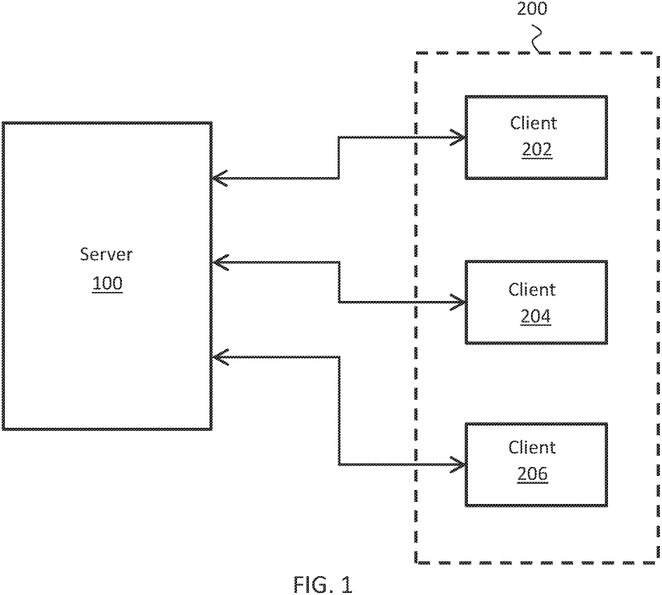

FIG. 1 is a block diagram of a network including a server 100 providing video streaming to a group of clients 200 with the H26Live transport method, in accordance with some embodiments. The server 100 may be or include a programmable computer, with a computer readable storage medium storing the H26Live programming for execution by the server 100. As illustrated in FIG. 1, the group of clients 200 includes a client 202, a client 204, and a client 206. However, the group of clients 200 may include any suitable number of clients, such as one client to one hundred million clients.

When, for example, the client 202 connects to an H26Live video stream provided by the server 100, the client 202 will receive the most recent I-frame of the H26Live video stream and will then receive delta frames following the I-frame. The delta frames will be sent by the server 100 until either another I-frame is requested by the client 202 or another I-frame is sent automatically by the server 100. The server 100 can make the I-frame available for matching with previous frame data, for compensating for missing information, upon request from the client 202, for configuration of the server 100, or other various quality requirements.

Clients (e.g. the client 202) may occasionally miss delta frames due to network issues such as network packet loss, degradation of internet signal, intermittent service loss, or other real-world network impediments. The H26Live video streaming protocol of this embodiment includes feedback from the client 202 to the server 100. This feedback informs the server 100 about the state of the multimedia playing conditions of the client 202 so that the server 100 can send an updated I-frame to improve the experience of the user. For example, if the client 202 detects that delta frames have been missed, the client 202 can then send feedback to the server 100 requesting an updated I-frame. This may rectify any streaming errors that have been introduced due to network issues. In other multimedia streaming protocols, servers are only provided feedback about when a client has connected or disconnected. With embodiments of the H26Live protocol, the server 100 receives feedback from the client and can send an updated I-frame quickly to rectify any streaming errors that have been introduced, e.g. due to network issues. This may yield better efficiency of network bandwidth and facilitate a better user experience. For example, based on feedback or request from the client 202, the server 100 may change the resolution of the video stream provided to the client 202 to improve the experience of the user.

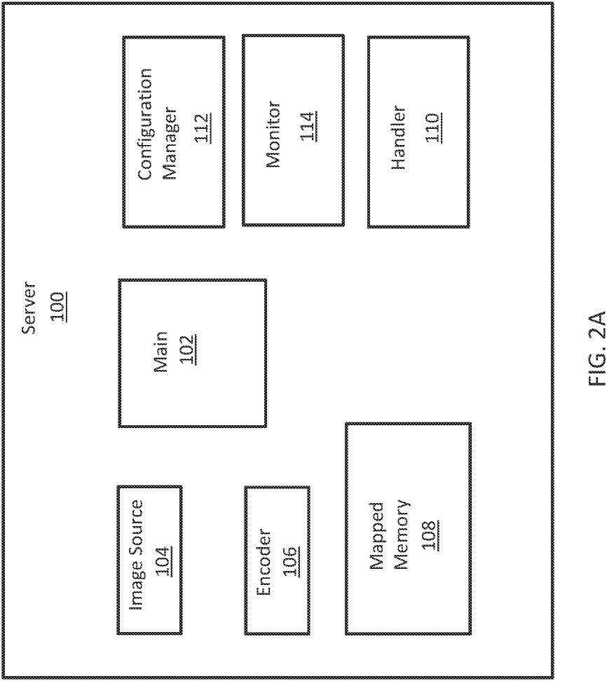

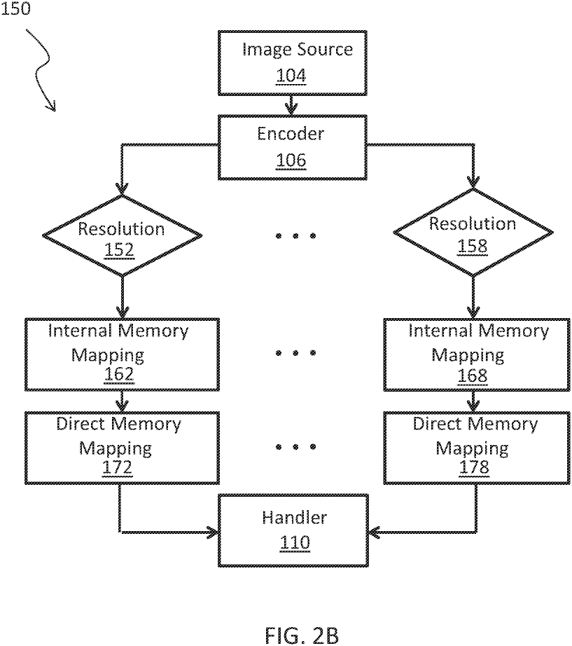

FIG. 2A is a block diagram of a server 100 with multiple H26Live server-side methods running on it, in accordance with some embodiments. The H26Live methods running on the server 100 include a main method 102, an image source method 104, an encoder method 106, a mapped memory method 108, a handler method 110, a configuration manager 112, and a monitor method 114.

The main method 102 is the starting point for the execution of the H26Live programming on the server 100. The main method 102 initializes the image source method 104, the encoder method 106, the mapped memory method 108, the handler method 110, the configuration manager 112, and the monitor method 114. The main method 102 controls execution of the H26Live programming on the server 100 by directing calls to the other methods of the H26Live programming on the server 100.

The image source method 104 accepts an argument (e.g., a numerical variable) identifying and indicating the location of the image source, such as low-level GPU memory, a video file, a camera device, an application programming interface (API), or other source of frames. The image source method 104 is configured to reduce the number of copies of frames provided to encoders (e.g., the encoder method 106). For example, when the image source of one or more frame(s) is a GPU, the image source method 104 may reduce the number of copies of frames by keeping the one or more frame(s) stored in the GPU rather than copying the one or more frame(s) to a new location. In some embodiments, the one or more frame(s) are stored in a GPU image buffer as a GPU memory address or pipe.

The image source may be any video source capable of transmitting a video stream to the server 100, e.g. computer systems, devices, cell phones, mobile robots, fixed position robots, or the like. As an example, the image source is a robot providing live video. The robot is capable of autonomous movement on legs, wheels, or any means of transportation. The robot is equipped with one or more electronic camera(s) capable of resolving live video. The robot may be connected to the server 100 by wireless or wired communication in order to provide images from the one or more electronic camera(s) to the image source method 104. The video stream from the robot may be encoded. In some embodiments, the server 100 is mounted onboard or otherwise physically integrated with the robot.

The encoder method 106 (also referred to as a frame encoder) takes the video provided in the image source method 104 and encodes a series of frames to make a video stream. After an initial I-frame and delta frame are encoded at the start of the video stream, each new frame to be encoded is based on the most recent I-frame and most recent delta frame that were previously encoded. The encoder method 106 encodes a new delta frame and a new I-frame for each resolution (e.g., 480p, 720p, 1080p, 4K, 8K, or the like) and rate of FPS (frames per second) to be provided to the clients 200.

The encoder method 106 checks that the delta frame is compatible with the most recent I-frame. This may be done by checking the timestamps and/or FrameID that the delta frame and most recent I-frame cover for a synchronization point. For example, the delta frame may differ by a set number of pixels in a range of zero pixels to the total number of pixels in the frame, such as 2,073,600 pixels in a frame with a resolution of 1920×1080. If the encoder method 106 finds that the delta frame is not compatible with the most recent I-frame, the encoder method 106 further checks that multiple sequences of delta frame paths between the most recent I-frame and the delta frame are available (e.g., from different GPUs) until proper matching between the delta frame and the I-frame occurs.

While the production of I-frames and delta frames will desirably be synchronized in such a manner to allow for delta frames and I-frames to produce the same image at each interval of time covered by the I-frames, this synchronization may not be achieved at times due to encoding distribution or other real-world sources of error. For example, an image source may have three successive instances of change from an image at Time 1: a first change at Time 2, a second change at Time 3, and a third change at Time 4. A video stream encoded from the image source may include a first I-frame for Time 1, a first delta frame accounting for the image change from the first I-frame to Time 2, a second I-frame made at Time 3, and a second delta frame made at Time 4 accounting for the image change from the first delta frame (at Time 2). In this case, the second delta frame is based upon frame data from Time 2 and is not compatible with the second I-frame made at Time 3, as the difference in image data between Time 2 and Time 3 is accounted for in both the second I-frame and the second delta frame. As such, the second delta frame made at Time 4 and any subsequent delta frames following from it cannot be used to follow from the second I-frame made at Time 3. If an incompatibility like this example occurs, the second delta frame made at Time 4 will be discarded or flagged as incompatible with the second I-frame made at Time 3. A new synchronization point will then be established so that subsequently generated delta frames can be re-synchronized with the second I-frame.

If a delta frame cannot be matched with the most recent I-frame as described in the above example due to, for example, local limitations in timing from image sources such as different GPUs or servers, then the encoder method 106 sets another I-frame as the send source for any query occurring later than the last combination of an I-frame and subsequent delta frames configured to match with it. However, the encoder method 106 is configured to prioritize having a single image frame specified for the latest I-frame and a specified delta frame that is built from the same image source as the latest I-frame. This allows a matching to occur that synchronizes the total net frame data between I-frames and delta frames at the creation of each I-frame in normal operation (i.e., the desirable synchronization that allows for delta frames and I-frames to produce the same image at each interval of time covered by the I-frames).

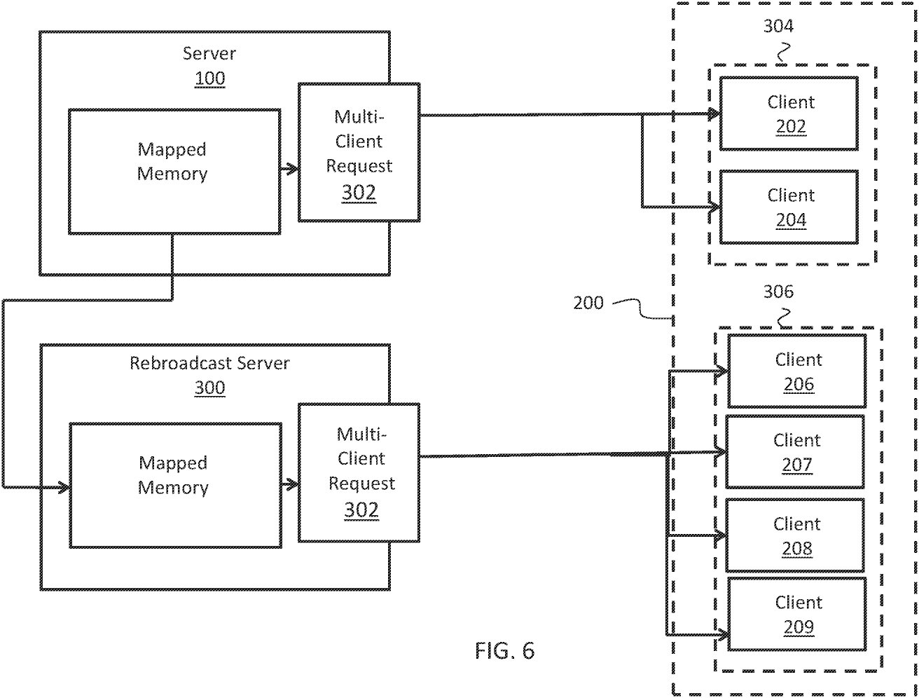

The encoder method 106 creates a stream of delta frames and I-frames (also referred to as an encoding stream or a feed) that can be fed into a frame directory of direct mapped memory (see discussion of the mapped memory method 108 below) on the server 100. This allows for the I-frames and subsequent delta frames associated with each I-frame to be accessible at the same time. The encoder method 106 encodes a series of frames (including I-frames and/or delta frames) for each of a set of image resolutions to be provided to the clients 200 (e.g., 480p, 720p, 1080p, 4K, 8K, or the like). Each of these frames will have a time associated with it and an ID (which will correspond to the memory host, frame timing, etc.). This may be provided as multiple simultaneous encoding streams for different resolutions and (if necessary) different timing requirements, such as if the image source includes different GPUs that are unsynchronized. Although the different encoding streams may be asynchronous in creation and hosting times, the timing of the frames in the different encoding streams as defined by the frame time and number is synchronous across all of different encoding streams. The clients 200 can select any of the different encoding streams at any time by other methods (see below, FIG. 6). The multiple simultaneous encoding streams for different resolutions (each including sets of I-frames and subsequent delta frames) are implemented as a dynamic sized set of resolution sets with a rotating modulus in direct mapped memory (see below, FIG. 2B).

As an example, a delta frame for a time t+1 will have the same final state as the corresponding I-frame for the time t+1. The final state is the combination of the delta frame for the time t+1 with the previous I-frame for the time t, which is equivalent to the I-frame for the time t+i. This allows a delta frame for a time t+2 to be applied to either the delta frame of t+1 or the I-frame of t+1. However, the multiple simultaneous encoding streams for various resolutions will not be directly correlated between each other like this. Switching between the multiple simultaneous encoding streams for various resolutions may be performed by new client requests for the latest I-frame of a different resolution encoding stream.

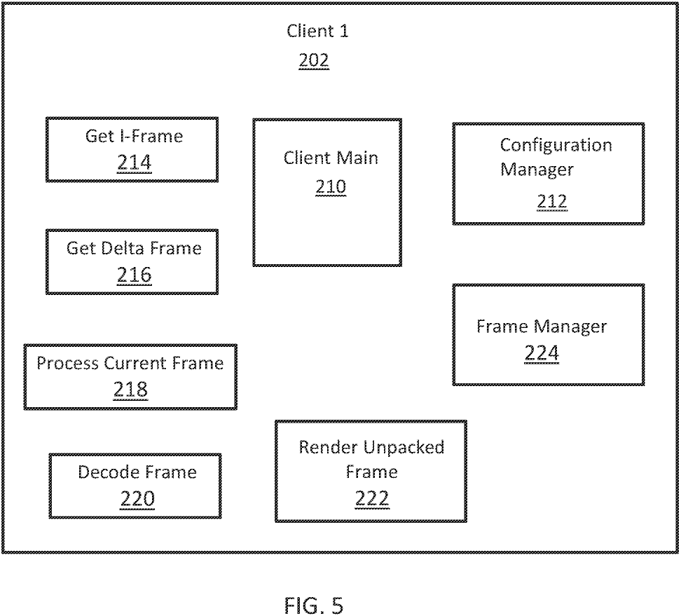

Additionally, the encoder method 106 provides an option for creating encoding streams having the same resolution but different frame rates (e.g., different FPS for each encoding stream). The encoder method 106 treats these encoding streams with different FPS the same as encoding streams having a different resolution overall. However, the encoder method 106 identifies the encoding streams with different FPS with different base FPS tag information in the overall feed and endpoint metadata. This also provides a FrameID for each frame, based on the source and encoded frame order of generation, which allows for mapping of the history of frames. A client (e.g., the client 202 as described below with reference to FIG. 5) may subsequently use the mapped history of the frames to determine the proper order to display the frames.

FIG. 2B is a flow chart illustrating multiple simultaneous encoding streams for different resolutions, in accordance with some embodiments. The image source method 104 provides a stream of images to the encoder method 106. The encoder method 106 then encodes the stream of images into multiple video streams with different resolutions, including a stream with a first resolution 152 and a stream with a last resolution 158. Although FIG. 2B illustrates two streams with different resolutions 152 and 158, any suitable number of streams with different resolutions may be produced by the encoder method 106, as indicated by the ellipsis between the stream with a first resolution 152 and the stream with a last resolution 158.

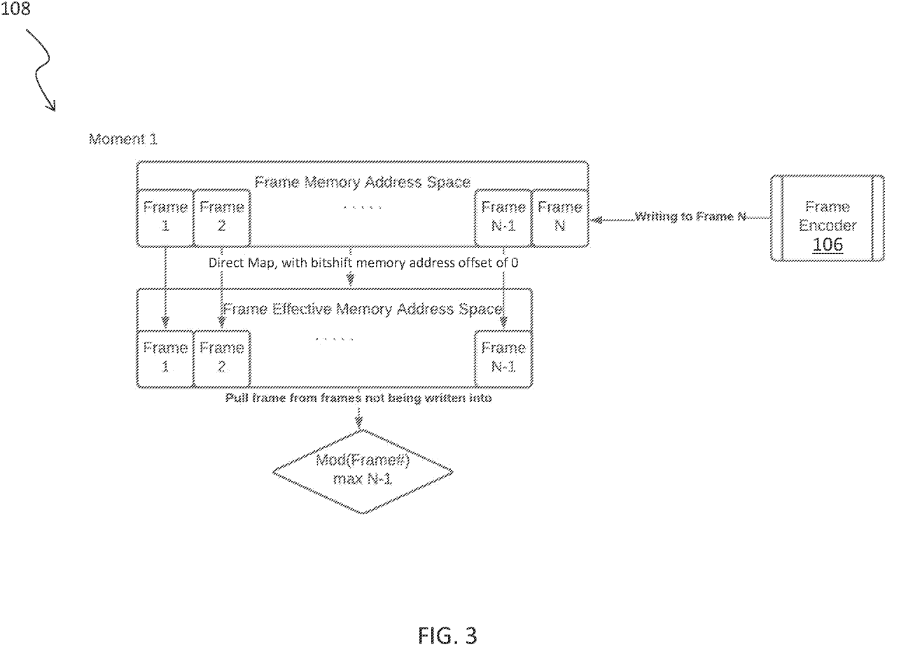

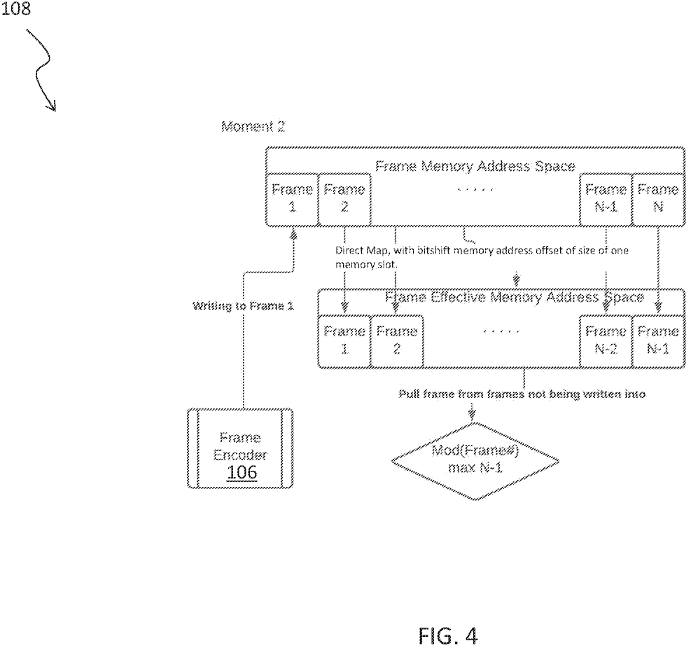

Next, the streams with different resolutions 152 to 158 are passed to the mapped memory method 108, which performs internal memory mappings 162 to 168 for the frames of each stream with different resolutions 152 to 158. The mapped memory method 108 implements the multiple simultaneous encoding streams for different resolutions 152 to 158 (each including sets of I-frames and subsequent delta frames) as a dynamic sized set of resolution sets with a rotating modulus in direct mapped memory, as described below with respect to FIGS. 3-4. Although FIG. 2B illustrates two internal memory mappings 162 and 168, any suitable number of internal memory mappings 162 to 168 for streams with different resolutions may be produced by the mapped memory method 108, as indicated by the ellipsis between the internal mappings 162 to 168.

Following the internal mappings 162 to 168 of the streams with different resolutions, the mapped memory method 108 prepares direct memory mappings 172 to 178 (e.g., to respective fixed memory buffers) for the frames of each stream with different resolutions 152 to 158. The direct memory mappings 172 to 178 are then provided to the handler method 110 (see below with respect to further discussion of FIG. 2A) for presentation to clients 200. Although FIG. 2B illustrates two direct memory mappings 172 and 178, any suitable number of direct memory mappings 172 to 178 for streams with different resolutions may be produced by the mapped memory method 108, as indicated by the ellipsis between the direct memory mappings 172 to 178.

The mapped memory method 108 receives a frame (e.g., an I-frame or a delta frame) and frame metadata by way of strict memory locations, pipes, or whatever provides a fast or fastest method on the system of the server 100. Metadata indicating a particular property of a particular frame need not be specified for that frame if the frame being contained in a known memory location will identify the frame as possessing that particular property. For example, memory addresses of I-frames may be stored in a first memory buffer and memory addresses of delta frames may be stored in a second memory buffer. It is not necessary to store metadata of a particular frame being either an I-frame or a delta frame as the location of the memory addresses of the frame in either the first memory buffer or the second memory buffer identifies the frame as either an I-frame or a delta frame, respectively. Shortening the metadata associated with each frame in this way is advantageous for increasing process speed.

The mapped memory method 108 storing the memory addresses of the frames allows for get requests (e.g., from the get I-frame method 214 or the get delta frame method 216 on a client 202, as described below with respect to FIG. 5) to point to these frames with a modulus method. Using the modulus method allows for the latest set of frames and frame history as specified by the configuration manager 112 (see below) to be maintained. In other words, a known set of memory locations will be presented with frame data for any given time.

Embodiments of the H26Live video streaming application may differ from other video streaming implementations (e.g., HSL) by, among other differences, including the mapped memory method 108 or not writing video files to permanent storage (e.g., a hard drive) as video file snippets as done by HSL. In some embodiments, rather than writing video files to permanent storage, H26Live operates so that video streams reside in RAM, cache, or other temporary memory storage. This is because in other implementations, the location in memory of frames changes between requests, which leads to updated maps or pointers being needed constantly for each set of frames. However, with the mapped memory method 108 of H26Live described herein, the memory addresses of frames are directly mapped to a shared memory location (e.g., a fixed memory buffer) that retains frame data with a modulus of the frame number. This is retained for both the latest I-frame and delta frame for each resolution to be presented by the server 100 to clients 200.

As the mapped memory method 108 writes the frames from the encoder method 106 into fixed memory buffers, it initially writes a frame header shift. This frame header shift allows for the frame number of a frame that has become invalid (e.g., by being too old relative to the latest presented frame generated in real time) to be set in a state that is recognized as invalid by the handler method 110 (see below). The handler method 110 will recognize that this frame is now invalid by way of comparison with the frame number of the latest presented frame. For example, the frame number of the invalid frame may be some number X and the frame number of the latest presented frame may be some number Y where Y is at least one offset of the total slots of frame memory locations in the fixed memory buffer from X. In other words, an offset of the total slots of frame memory locations in the fixed memory buffer from the frame number latest presented frame indicates that a frame is no longer valid.

FIG. 3 shows the operation of the mapped memory method 108 at an example Moment 1 and FIG. 4 shows the operation of the mapped memory method 108 at an example Moment 2 immediately following from Moment 1, in accordance with some embodiments. The write procedure of the mapped memory method 108 to a direct mapped memory buffer will override any pulls from a frame with its location being encoded into the direct mapped memory buffer. As such, the actual modulus of the direct mapped memory is at least one full frame more than the actual limit in modulus. The frame memory location base modulus has an appended bit shift applied to the memory pointer to the frame, which allows for request(s) from the handler method 110 (see below) to be pointed to frame memory locations which are not receiving writes from the mapped memory method 108.

For example, FIG. 3 shows that in Moment 1 if a Frame N is receiving writes (e.g., from the encoder method 106), then the mapped memory method 108 will present only the first N-1 frames as the total frames that are available in a frame effective memory address space. The N frame is made unavailable for pulling by the mapped memory method 108 performing a bit shift of memory addresses with an offset of zero memory slots. The bit shifts used to perform the modulus operations on memory addresses are extremely fast operations that allow the exemplary H26Live application to provide real time video streaming to multiple clients 200.

FIG. 4 shows a Moment 2 following from Moment 1 in which Frame 1 is receiving writes (e.g., from the encoder method 106). The mapped memory method 108 then performs a bit shift of the other memory addresses (Frames 2 through N) with an offset of one memory slot. This allows for Frame 1 to go out of cycle (being made inaccessible for pulls), which leaves Frames 2 through N accessible for pulling in a frame effective memory address space. However, the endpoints of the video stream (e.g., the client 202) do not observe this memory address shift as the original memory addresses of the frames sent to the endpoints (e.g., by the handler method 110) are unchanged. In a subsequent Moment 3 following Moment 2 (not illustrated) in which another frame (e.g., Frame 2) is receiving writes from the encoder method 106, a partial shift of effected memory addresses (e.g., bit shifting memory addresses from a range of 3 to N to a range of 2 to N-1) may be used instead of a larger shift of, e.g., a range of 2 to N to a range of 1 to N-1. However, the range of 1 to N-1 may also be used to receive writes in Moment 3, as all memory blocks not currently receiving writes are accessible to future writes.

Referring back to FIG. 2A, the handler method 110 provides information about frames of H26Live video streams to clients 200 (e.g., locations and status of the frames in direct mapped memory set by the mapped memory method 108). The handler method 110 accepts requests for frames from a time in the past (in terms of number of frames) determined by a configured buffer limit up to the start of the H26Live video stream. The handler method 110 further allows for the handling of requests from the clients 200 for frames that will be generated in the near future (near-term frames). Future queueing of near-term frames is allowed because the direct memory mapping of the mapped memory method 108 (see above, FIGS. 3-4) establishes the memory locations of near-term frames before they are written to memory. The clients 200 may request near-term frames by requesting their respective memory addresses. The availability of each frame is indicated when the respective memory address of each frame is bit shifted during a writing operation on a subsequently produced frame. The handler method 110 then sends out the near-term frames as soon as the near-term frames are indicated as available by the bit shifting of their respective mapped memory addresses. Client overhead is reduced because there is no need to look up a particular memory address for a requested frame, as the requests from the clients 200 are for memory addresses of the frames in direct mapped memory. Near-term frames may be requested up to a limit determined by, e.g., calculation of a delay in processing from the live source occurrence of the video stream. As an example of the calculation of the limit, a frame may be generated at some time X units of time in the past with an additional Y units of time to process and receive the frame after the request. Therefore, the clients 200 may request a number of frames yet to be generated up to an estimated X+Y units of time in the future from the frame that is currently estimated to be generated. The limit may also include real world possible delays in order to be within real world limits observed in the environment at hand of the image source. These may be configurable parameters and/or based on worst observed network or processing delays that are not outliers or due to complete loss of network connection.

The handler method 110 provides a series of endpoints accessible to clients 200. For example, a client 202 may request a frame X of type Y (e.g., an I-frame or a delta frame) with some resolution Z. If the frame X is available, the handler method 110 directly sends it out to the client 202 (e.g., by a memory copy of frame X to the network stack). If the frame X is older than allowed by the size of the direct memory mapping buffer, then the frame X is no longer a valid output and the handler method 110 returns a timeout to the client 202 in addition to the latest available I-frame in the same stream (e.g., with the same resolution and FPS), in order to allow the client 202 to re-configure its request timing. If the frame X is in the future relative to the request from the client 202 but is still within the set limit for available future frames, the handler method 110 retains the request and returns the frame X to the client 202 as soon as the frame X is available. If the frame X is in the future relative to the request from the client 202 but is beyond the set limit for available future frames, the handler method 110 returns a timing error to the client 202 in addition to the latest I-frame, in order to allow the client 202 to re-configure its request timing.

If a frame request will take longer to provide than the write operation of the next subsequently generated frame (e.g., if the client request arrives late and a new frame is in the process of being generated), the handler method 110 will instead provide the latest proper frames(s) after the write operation, such as whichever is most efficient of the latest I-frame or series of delta frames, in anticipation of the next frame needs of the client 202. This will reduce or prevent cases where the frame effective memory address space (see above, FIGS. 3-4) shifts during the write operation.

The series of endpoints for the handler method 110 described above include different limits on total frames to be kept for each combination of image resolution and FPS. The endpoints provided by the handler method 110 allow for scanning by clients 200 as well as endpoints for communication of feed metadata, such as an endpoint for available resolutions, an endpoint for available FPS, an endpoint listing various streams from other simulcasting servers (see below, FIG. 6) for the clients 200 to switch to as needed, or the like. For example, the clients 200 may contact the endpoint for available FPS to get a list of available FPS streams that may be requested.

The configuration manager 112 reads configurations for the H26Live methods on the server 100 at pre-run and/or during runtime. The configuration manager 112 may also dynamically adjust configurations based on stream conditions and/or hardware conditions during runtime of the H26Live video streaming. This may change the runtime settings of other methods and/or functions on the server 100, e.g. the encoder method 106 and the handler method 110, which modifies how the other methods and/or functions on the server 100 operate based on these configurations. These configurations may be related to size of video playback, system utilization limitations, default framerate, or the like. The configuration manager 112 also configures the behavior of the monitor method 114 (see below).

The configuration manager 112 also sends data and receives requests from the clients 200 or other servers (e.g., H26Live rebroadcast servers 300, see below FIG. 6) with information on current available stream configurations and status and information of other nodes in the system. For example, the configuration manager 112 may provide information to the client 202 that: a first video stream is available on the server 100 as a 4K 120 FPS stream and a 1080p 220 FPS stream; a second video stream at 720p is available on another server A; another server Q is available as a rebroadcast server for the streams of server 100; and an 8k video stream on the server 100 is no longer functioning due to, e.g., packet loss issues. The above request receiving and sending data may be either integrated with other methods of the configuration manager 112 or may be executed as a standalone endpoint.

The monitor method 114 monitors the system resources of the server 100 to manage availability of system resources and reduce or increase options for streaming endpoints based on system availability. The monitor method 114 may increase the quality of the video stream without requiring intervention by the user, e.g. the user observing visually that the image quality is poor. For example, if a stream encoded with 4k resolution is failing, then the monitor method 114 presents other options to the clients 200 (e.g., streams with other resolutions and/or on other servers), flags and reports that the encoding of the 4k stream is failing, and removes the 4k feed out of availability for the clients 200. The monitor method 114 also monitors client requests such that if the server 100 is receiving too many requests or network conditions are poor, the monitor method 114 notifies the respective monitor(s) and admin(s) of other instance(s) of H26Live (e.g., running on other servers) for response. If the H26Live application on the server 100 is unstable, the monitor method 114 attempts to repair, restart, or otherwise handle the situation with actions controlled by a set of options that are available to the monitor method 114 as, e.g., environment variables. For example, if the monitor method 114 detects that no frames are being generated on the server 100, the monitor may trigger a reboot of the H26Live software on the server 100.

FIG. 5 illustrates a client 202 with multiple H26Live client-side methods running on it, in accordance with some embodiments. The client 202 is programmed with a client main method 210, a configuration manager 212, a get I-frame method 214, a get delta method 216, a process current frame method 218, a decode frame method 220, a render unpacked frame method 222, and a frame manager 224. The client 202 may be any suitable device for receiving or displaying streaming video, such as a computer, a smartphone, a virtual reality (VR) or augmented reality (AR) headset, or the like.

The client main method 210 is the starting point for the execution of the H26Live programming on the client 202. Upon launching the H26Live client-side application, the client main method 210 asynchronously starts the frame manager 224, requests the first I-frame through the get I-frame method 214, and requests a delta frame through the get delta frame method 216. The requested delta frame may not yet have been generated when the client main method 210 sends the request. The client main method 210 then iterates through multiple cycles for retrieving and displaying additional frames. Each iteration of the cycle invokes the process current frame method 218, which retrieves the most recent frame from the memory buffer of the H26Live client application and renders to a screen or other output device connected to the client 202 for the user. The client main method 210 may also check that the other H₂6Live methods on the client 202 are properly threaded.

The configuration manager 212 reads configurations for the H26Live methods at pre-run and/or during runtime of the client 202. The configuration manager 212 may also dynamically adjust configurations based on stream conditions and/or hardware conditions during runtime, which will change the runtime settings of other methods and/or functions (e.g., the get I-frame method 214 or the get delta frame method 216). This will modify how the other elements of the client operate based on these configurations. These may be related to size of video playback, system utilization limitations, default framerate, or the like.

The configuration manager 212 may also request and receive the current configuration of the streaming environment from the configuration manager 112 of the server 100 (or another suitable endpoint configured to supply the current configuration of the streaming environment). The current configuration of the streaming environment contains data such as current available servers, current frame rate options, current resolution options, current memory buffer frame size (in order to limit requests from the client 202 within the memory buffer frame size), and other operational data and status information of currently available video streams. The configuration data (including available options for servers, frame rates, and resolutions) is supplied to other methods such as, for example, the frame manager 224 (see below) when making processing decisions to improve operations.

The get I-frame method 214 accepts a parameter FrameID as an argument, where FrameID is a parameter identifying the frame requested by the client main method 210 or the frame manager 224. For example, the FrameID may be a memory address (e.g., in a GPU). The get I-frame method 214 utilizes a previously established network socket (reserved for command communications between the server 100 and clients 200) to send a packet of information to the server 100. The packet of information sent to the server contains the FrameID of the I-frame that is requested. After the request packet has been sent, the get I-frame method 214 asynchronously waits for a response from the server 100. The expected response from the server 100 is the desired I-frame associated with the FrameID that was initially requested by the get I-frame method 214.

The get delta frame method 216 accepts a parameter FrameID as an argument, where FrameID is a parameter identifying the frame requested by the client main method 210 or the frame manager 224. For example, the FrameID may represent a memory address (e.g., a modulus resolvable address in the frame effective memory address space). The get delta frame method 216 utilizes the previously established network socket to send a packet of information to the server 100 containing the FrameID of the requested delta frame. After the request packet has been sent, the get delta frame method 216 asynchronously waits for the response from the server 100. The response from the server 100 is the desired delta frame associated with the FrameID that was initially requested by the get delta frame method 216. If a delta frame is not available for the requested FrameID, the closest I-frame to the temporal location of the requested delta frame may be returned by the get delta frame method 216 instead of the requested delta frame.

The process current frame method 218 pulls the most recent frame from the memory buffer of the H26Live client application. The process current frame method 218 then inspects the most recent frame to determine its properties, such as whether the memory location in the memory buffer contains a frame, whether the frame is an I-frame or a delta frame, or whether the frame is corrupt. If the frame is found to be corrupt or otherwise unacceptable, the process current frame method 218 will signal the frame manager 224, whereupon the frame manager 224 can request the frame again. If the frame appears to be uncorrupt, the frame is then asynchronously sent to the decode frame method 220. Subsequent to this point in processing of the frame, the client-side H26Live program preferably attempts to reduce copies in memory and to keep the frame data on the decoding / render pipeline of the processor (e.g., a GPU) of the client 202 where possible as managed by the process current frame method 218, decode frame method 220, and render unpacked frame method 222.

The decode frame method 220 receives a frame as an argument and can accommodate a variety of video compression formats and encode methodologies. After the decode frame method 220 receives a frame, the frame is unpacked and the unpacked frame is inspected. If the unpacked content of the frame is found to be corrupt or otherwise unacceptable, the decode frame method 220 will signal the frame manager 224, whereupon the frame manager 224 can request the frame again. If the frame is not corrupt, decode frame method 220 will send the unpacked frame to the render unpacked frame method 222.

The render unpacked frame method 222 receives an unpacked frame from the decode frame method 220. Upon receipt of the unpacked frame, the render unpacked frame method 222 simultaneously decodes the unpacked frame and renders the unpacked frame to a graphical pipeline of the client 202 for display. The render unpacked frame method 222 uses software decoding methodologies, hardware accelerated decoding methodologies, hardware decoding methodologies, the like, or any combination thereof.

The frame manager 224 manages the FrameID parameters for frames currently in the memory of the client 202 and for any future frames to be requested. The frame manager 224 makes requests to the server 100 at timed intervals for the current delta frame and a yet-to-be-generated future delta frame through the get delta frame method 216 using arguments FrameID and FrameID+1, respectively.

The frame manager 224 manages the current FrameID and calculates potential future FrameIDs for the H26Live application on the client 202. The frame manager 224 also packs the frame memory buffer of the H26Live application as frames arrive at the client 202 over the network from, e.g., the server 100. The frame memory buffer is managed in a first in first out (FIFO) queue in which the most recent frame is stored on the top of the queue when frames arrive over the network from, e.g., the server 100. As the frame manager 224 detects an I-frame as it arrives on the client 202, the I-frame with the highest FrameID is placed on the top of the frame memory buffer, for immediate use.

As the frame manager 224 monitors the network and packs the frame memory buffer of the H26Live application, the frame manager 224 also monitors the timing of the video frames that are coming in and determines current network conditions including, for example, delays in frame arrival times. If the frame manager 224 detects that the frames are arriving with a delay large enough to cause the client 202 to fall behind in playing the video stream relative to the processing of the stream by the server 100, or that the device of the client 202 cannot handle the resolution and frame rate of the current video stream, the frame manager 224 can request a reduced resolution or frame rate for the video stream from the server 100.

As the frame manager 224 packs the frame memory buffer of the H26Live application, the frame manager 224 asynchronously schedules and triggers the process current frame method 218 (see above). This pulls the most current frame from the frame memory buffer of the H26Live application, thereby starting the process to decode and render the frame.

As the frames are being processed (e.g., by the process current frame method 218 or the decode frame method 220), the frame manager 224 also monitors signals from the process current frame method 218 or the decode frame method 220 to check if corruption of the frame (e.g., during network transportation or introduced on the server 100) has occurred, or if the frame is otherwise unacceptable. If such corruption has occurred, the frame manager 224 will re-request the delta frame or I-frame from the server 100.

While packing the frame memory buffer of the H26Live application, the frame manager 224 also monitors the frame memory buffer for missing frames. If a frame is found to be missing after a dynamically calculated period of time (e.g., a dynamically calculated processing time plus a time to receive the next delta frame in the future plus the network transmission time), the frame manager 224 will request the missing frame. If too much time has elapsed so that the latest image on the client 202 can no longer be properly updated by a delta frame, the frame manager 224 clears the frame memory buffer, cancel outstanding frame requests on the server 100, and asynchronously requests an I-frame through the get I-frame method 214 with an argument FrameID and a yet-to-be-generated future delta frame through the get delta frame method with an argument FrameID+1.

The frame manager 224 also determines if or when the client 202 should switch to other simulcasting servers based on overall server and network conditions and performance times (such as if the server 100 is not responding in time, if a large number of frames are failing while overall network conditions are okay, or the like).

FIG. 6 is a block diagram of a network including a server 100, a rebroadcast server 300, and a group of clients 200, in accordance with some embodiments. When multiple clients 200 are connected to the same server (e.g., the server 100) running H26Live software, the H26Live application allows for multiple options to handle increased traffic from the multiple clients 200. These options may be used separately or in any combination with each other.

As a first option, the server 100 directly handles requests from the multiple clients 200 directly. This option has the same operation as described for the server 100 connecting with the client 202 (see above, FIGS. 2-5) but with additional clients 200 connecting to the server 100. Frames stored in direct mapped memory of the server 100 are requested by multi-client requests 302 from clients 200. However, this option may not scale to a very large pool of clients (e.g., a number of clients in a range of ten clients to one hundred million clients, depending on the capabilities of the server 100) due to the added processing and bandwidth needed. As such, this option may be limited to a priority client pool 304 having a smaller number of clients. Clients in the priority client pool 304 may have a higher priority or may be clients that benefit from as fast as possible a connection to the server 100. Although the priority client pool 304 is illustrated as having two clients 202 and 204, it may have any suitable number of clients, such as a number of clients in a range of one client to one hundred million clients.

As a second option, the network may include one or more rebroadcast servers 300. A rebroadcast server 300 is a dedicated server running H26Live software that provides the same output to clients 200 as standard H26Live servers (e.g., a server 100 as described above with respect to FIG. 2A). However, including one or more rebroadcast servers 300 in the network allows for a separate server pool to spread out the processing and bandwidth. The rebroadcast server 300 pulls frames in a similar method to clients 200 as described above with respect to FIG. 5 from either the server 100 or another rebroadcast server 300 (not illustrated). The rebroadcast server 300 performs a memory copy of all frame stacks available in the server 100. Upon receiving multi-client requests 302, the rebroadcast server 300 provides frames to a non-priority client pool 306, which may be larger than the priority client pool 304. Although the non-priority client pool 306 is illustrated as having four clients 206, 207, 208, and 209, it may have any suitable number of clients, such as a number of clients in a range of one client to one hundred million clients.

As a third option (not illustrated in FIG. 6), an additional H26Live server (similar to the server 100) pulls an image source (e.g., source frame(s) stored in the direct mapped memory of the server 100) from the server 100 to use for its own parallel processing of the video stream. In this case, the frame source for the additional H26Live server is a get method that points to the raw presented frame or frame copy on the server 100. This allows for a separate set of source encoding such that the server 100 may be encoding to 4k while the additional H26Live server is encoding to a different resolution (e.g., 720p or 1080p). The first option and the second option may be used in conjunction with the third option. In other words, the server 100 may directly handle requests from a priority client pool 304, one or more rebroadcast servers 300 may handle requests from a non-priority client pool 306, and the additional H26Live server may provide video streams at different resolutions or frame rates from the server 100.

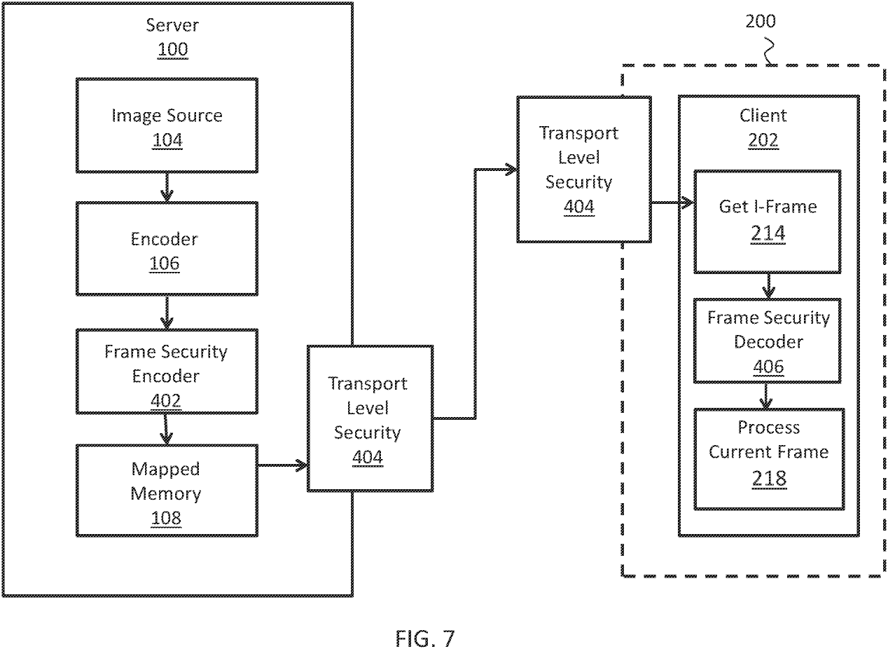

FIG. 7 is a block diagram of a network including a server 100 and a client 202 with various encryption methods, in accordance with some embodiments. Standard streaming systems include authentication and authorization layer for their connections, as well as other standard network security methods for accessing stream endpoints or getting responses from get requests. These standard security measures are not detailed here, and it may be appreciated that standard network security endpoint authorization and authentication implementations are wrapped around the processes in this disclosure. When there is a desire for encryption of the H26Live video stream (e.g., to reduce the probability of the video stream from being accessible by unwanted parties conducting man-in-the-middle attacks, the following methods can be used.

As a first example, transport level security 404 is implemented between the server 100 and the client 202. In some embodiments, the transport level security 404 is Standard Transport Security. The Transport Layer Security (TLS) protocol is an industry standard designed to help protect the privacy of information communicated over the Internet. TLS 1.2 is a standard that provides security improvements over previous versions. TLS 1.2 will eventually be replaced by the newest released standard TLS 1.3 which is faster and has improved security. Other security protocols are, of course, within the contemplated scope of this disclosure.

As a second example, a frame security encoder 402 is implemented on the server 100 and a frame security decoder 406 is implemented on the client 202. The frame security encoder 402 encrypts the actual frames as they are encoded (e.g., by the encoder method 106 on the server 100, as described above with respect to FIG. 2A). The frame security encoder 402 takes the frames about to be stored in the direct mapped memory of the server 100 and performs an industry standard or customized encryption on them (e.g., RSA). The encrypted frames are subsequently decoded by the frame security decoder 406 after the client 202 receives the frame (e.g., from a request by the get I-frame method 214) and before the received frame is processed (e.g., by the process current frame method 218).

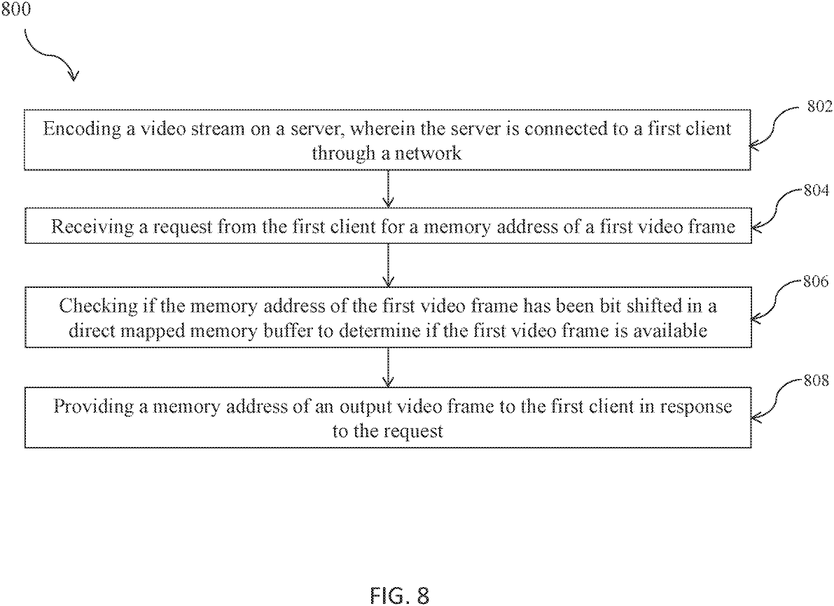

FIG. 8 is a flow chart of a method 800 for streaming live video, in accordance with some embodiments. In step 802, a video stream is encoded on a server 100, as described above with respect to FIG. 2A. The server 100 is connected to a client 202 through a network, as described above with respect to FIG. 1. In step 804, a request is received from the client 202 for a memory address of a first video frame, as described above with respect to FIG. 2A. In step 806, the memory address of the first video frame is checked if it has been bit shifted in a direct mapped memory buffer to determine if the first video frame is available, as described above with respect to FIG. 2A. In step 808, a memory address of an output video frame is provided to the client 202 in response to the request, as described above with respect to FIG. 2A.

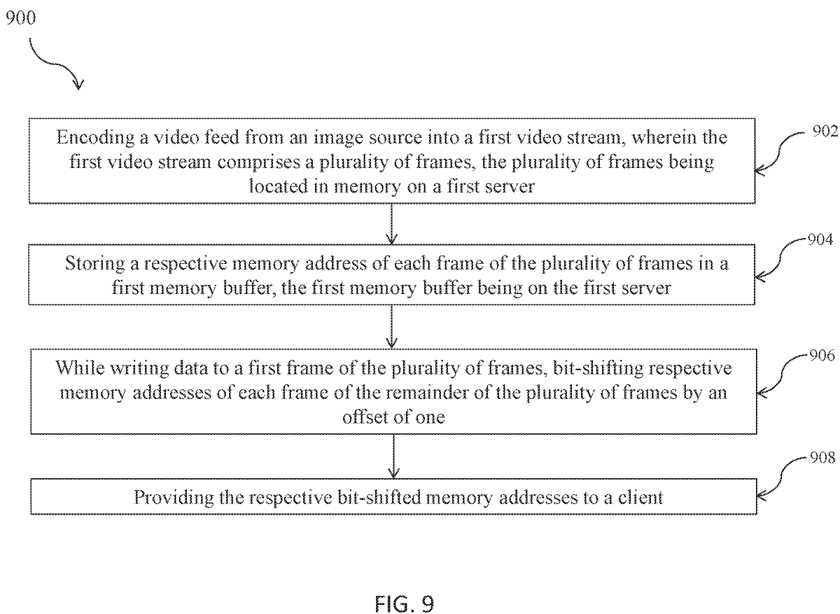

FIG. 9 is a flow chart of a method 900 for streaming live video, in accordance with some embodiments. In step 902, a video feed from an image source method 104 is encoded into a first video stream, wherein the first video stream comprises a plurality of frames, the plurality of frames being located in memory on a first server 100, as described above with respect to FIG. 2A. In step 904, a respective memory address of each frame of the plurality of frames is stored in a first memory buffer, the first memory buffer being on the first server 100, as described above with respect to FIG. 2A. In step 906, while writing data to a first frame of the plurality of frames, respective memory addresses of each frame of the remainder of the plurality of frames are bit shifted by an offset of one, as described above with respect to FIGS. 3-4. In step 908, the respective bit shifted memory addresses to a client 202, as described above with respect to FIG. 2A.

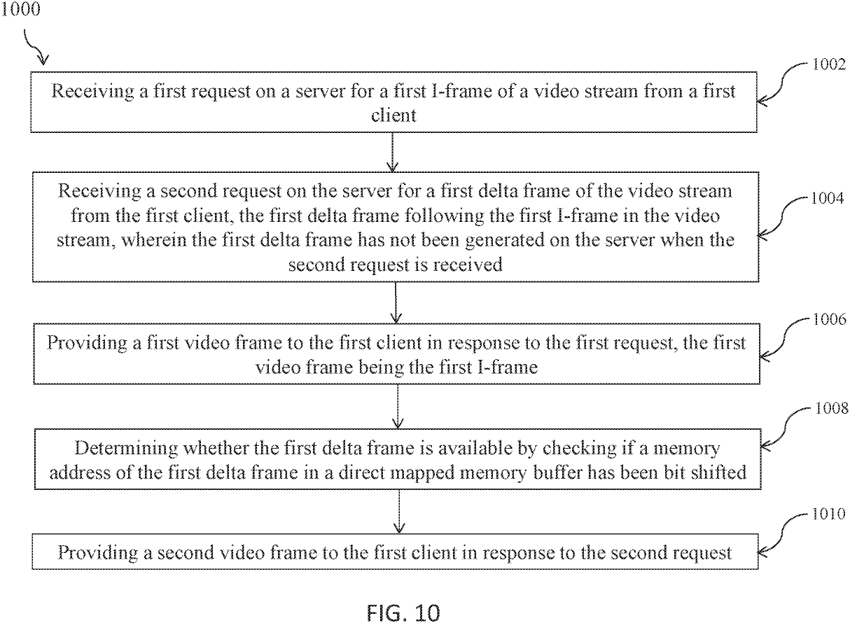

FIG. 10 is a flow chart of a method 1000 for streaming live video, in accordance with some embodiments. In step 1002, a first request is received on a server 100 for a first I-frame of a video stream from a client 202, as described above with respect to FIG. 5. In step 1004, a second request is received on the server 100 for a first delta frame of the video stream from the client 202, the first delta frame following the first I-frame in the video stream, wherein the first delta frame has not been generated on the server 100 when the second request is received, as described above with respect to FIG. 5. In step 1006, a first video frame is provided to the client 202 in response to the first request, the first video frame being the first I-frame, as described above with respect to FIG. 5. In step 1008, whether the first delta frame is available is determined by checking if a memory address of the first delta frame in a direct mapped memory buffer has been bit shifted, as described above with respect to FIG. 5. In step 1010, a second video frame is provided to the client 202 in response to the second request, as described above with respect to FIG. 5.

Example embodiments of the disclosure are summarized here. Other embodiments can also be understood from the entirety of the specification as well as the claims filed herein. Example 1. A method for streaming live video, including: encoding a video stream on a server, where the server is connected to a client through a network; receiving a request from the client for a memory address of a first video frame; checking if the memory address of the first video frame has been bit shifted in a direct mapped memory buffer to determine if the first video frame is available; and providing a memory address of an output video frame to the client in response to the request.

Example 2. The method of example 1, where the first video frame is available when the request from the client is received and the output video frame is the first video frame.

Example 3. The method of example 1, where the first video frame is not available when the request from the client is received, the request is retained until the first video frame becomes available, and the memory address of the output video frame is provided when the first video frame becomes available, the output video frame being the first video frame.

Example 4. The method of example 1, where the first video frame is not available when the request from the client is received and the output video frame is not the first video frame.

Example 5. The method of example 1, where the direct mapped memory buffer is free of metadata that indicates whether the first video frame is an I-frame or a delta frame.

Example 6. The method of example 1, where the output video frame is stored in a GPU when the memory address of the output video frame is provided to the client.

Example 7. The method of example 1, further including receiving feedback from the client on streaming errors; and sending an updated I-frame to rectify the streaming errors.

Example 8. A method for streaming live video, including: encoding a video feed from an image source into a first video stream, where the first video stream includes a plurality of frames, the plurality of frames being located in memory on a first server; storing a respective memory address of each frame of the plurality of frames in a first memory buffer, the first memory buffer being on the first server; while writing data to a first frame of the plurality of frames, bit shifting respective memory addresses of each frame of the remainder of the plurality of frames by an offset; and providing the respective bit shifted memory addresses to a client.

Example 9. The method of example 8, where the first memory buffer is used to store I-frames and is free of delta frames.

Example 10. The method of example 8, where the first memory buffer is used to store delta frames and is free of I-frames.

Example 11. The method of example 8, further including encoding the video feed into a second video stream, where the second video stream has a different resolution from the first video stream.

Example 12. The method of example 8, further including encoding the video feed into a second video stream, where the second video stream has a different frame rate from the first video stream.

Example 13. The method of example 8, further including encoding the video feed into a second video stream, where the second video stream is located on memory in a second server, the second server being different from the first server.

Example 14. The method of example 8, where the offset is one.

Example 15. A computer with a computer readable storage medium storing programming for execution by the computer, the programming including instructions to: receive a first request on the computer for a first I-frame of a video stream from a client; receive a second request on the computer for a first delta frame of the video stream from the client, the first delta frame following the first I-frame in the video stream, where the first delta frame has not been generated on the computer when the second request is received; provide a first video frame to the client in response to the first request, the first video frame being the first I-frame; determine whether the first delta frame is available by checking if a memory address of the first delta frame in a direct mapped memory buffer of the computer has been bit shifted; and provide a second video frame to the client in response to the second request.

Example 16. The computer of example 15, where the second video frame is the first delta frame.

Example 17. The computer of example 15, where the second video frame is a second I-frame.

Example 18. The computer of example 17, where the second I-frame is a closest I-frame available on the computer to a temporal location of the first delta frame.

Example 19. The computer of example 15, where the programming further includes instructions to monitor a feedback channel for an indication of a missing frame from the client.

Example 20. The computer of example 19, where the programming further includes instructions to receive from the client through the feedback channel a request for a second I-frame and a second delta frame.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for streaming live video, comprising:
encoding a video stream on a server, wherein the server is connected to a client through a network;
receiving a request from the client for a memory address of a first video frame;
checking if the memory address of the first video frame has been bit shifted in a direct mapped memory buffer to determine if the first video frame is available; and
providing a memory address of an output video frame to the client in response to the request.

2. The method of claim 1, wherein the first video frame is available when the request from the client is received and the output video frame is the first video frame.

3. The method of claim 1, wherein the first video frame is not available when the request from the client is received, the request is retained until the first video frame becomes available, and the memory address of the output video frame is provided when the first video frame becomes available, the output video frame being the first video frame.

4. The method of claim 1, wherein the first video frame is not available when the request from the client is received and the output video frame is not the first video frame.

5. The method of claim 1, wherein the direct mapped memory buffer is free of metadata that indicates whether the first video frame is an I-frame or a delta frame.

6. The method of claim 1, wherein the output video frame is stored in a GPU when the memory address of the output video frame is provided to the client.

7. The method of claim 1, further comprising:
receiving feedback from the client on streaming errors; and
sending an updated I-frame to rectify the streaming errors.

8. A method for streaming live video, comprising:
encoding a video feed from an image source into a first video stream, wherein the first video stream comprises a plurality of frames, the plurality of frames being located in memory on a first server;
storing a respective memory address of each frame of the plurality of frames in a first memory buffer, the first memory buffer being on the first server;
while writing data to a first frame of the plurality of frames, bit shifting respective memory addresses of each frame of the remainder of the plurality of frames by an offset; and
providing the respective bit shifted memory addresses to a client.

9. The method of claim 8, wherein the first memory buffer is used to store I-frames and is free of delta frames.

10. The method of claim 8, wherein the first memory buffer is used to store delta frames and is free of I-frames.

11. The method of claim 8, further comprising:
encoding the video feed into a second video stream, wherein the second video stream has a different resolution from the first video stream.

12. The method of claim 8, further comprising:
encoding the video feed into a second video stream, wherein the second video stream has a different frame rate from the first video stream.

13. The method of claim 8, further comprising:
encoding the video feed into a second video stream, wherein the second video stream is located on memory in a second server, the second server being different from the first server.

14. The method of claim 8, wherein the offset is one.

15. A computer with a computer readable storage medium storing programming for execution by the computer, the programming including instructions to:
receive a first request on the computer for a first I-frame of a video stream from a client;
receive a second request on the computer for a first delta frame of the video stream from the client, the first delta frame following the first I-frame in the video stream, wherein the first delta frame has not been generated on the computer when the second request is received;
provide a first video frame to the client in response to the first request, the first video frame being the first I-frame;
determine whether the first delta frame is available by checking if a memory address of the first delta frame in a direct mapped memory buffer of the computer has been bit shifted; and
provide a second video frame to the client in response to the second request.

16. The computer of claim 15, wherein the second video frame is the first delta frame.

17. The computer of claim 15, wherein the second video frame is a second I-frame.

18. The computer of claim 17, wherein the second I-frame is a closest I-frame available on the computer to a temporal location of the first delta frame.

19. The computer of claim 15, wherein the programming further includes instructions to monitor a feedback channel for an indication of a missing frame from the client.

20. The computer of claim 19, wherein the programming further includes instructions to receive from the client through the feedback channel a request for a second I-frame and a second delta frame.
